(19) United States
(12) Patent Application Publication
(10) Pub. No.: US 2016/0129477 A1
(43) Pub. Date: May 12, 2016

(54) TROMMEL ASSEMBLY HAVING A SPIRAL ASSEMBLY WITH DECAYING PITCH

(71) Applicants: TEGA INDUSTRIES LIMITED, Kolkata (IN); INDIAN INSTITUTE OF TECHNOLOGY, KHARAGPUR, Kharagpur, West Bengal (IN)

(72) Inventors: Vikranth Racherla, Kharagpur, West Bengal (IN); Santanu Dashmahapatra, Kolkata, West Bengal (IN); Tanmay Moharana, Kolkata, West Bengal (IN); Biswadeep Paul, Kolkata, West Bengal (IN)

(73) Assignees: Tega Industries Limited, Kolkata, West Bengal (IN); Indian Institute of Technology, Kharagpur, Kharagpur, West Bengal (IN)

(21) Appl. No.: 14/889,671

(22) PCT Filed: May 8, 2014
(86) PCT No.: PCT/IN2014/000312

§ 371 Date: Nov. 6, 2015

(30) Foreign Application Priority Data
May 9, 2013 (IN) 527/KOL/2013

(51) Int. Cl. B07B 1/22

(52) U.S. Cl. CPC B07B 1/22

(57) ABSTRACT

The trommel assembly (1) with a spiral assembly having a decaying spiral pitch (3) comprises rotating drum structure with the decaying spiral assembly (2) and screen panels (6) made of polymeric material or rubber compounds. The pitch (3) is at a maximum at the inlet and at a minimum at the outlet providing increased screening efficiency. Maximum pitch produces low media height with increased inlet velocity and minimum pitch increases media height. The spiral (2) is of single start, double start or multi start configuration. The pitch (3) decreases along the trommel such that screening efficiency is improved without affecting the retention time.

### FIELD OF THE INVENTION

The present invention in general relates to a trommel screen assembly and more particularly to an improved trommel screen assembly with decaying spiral pitch in order to increase screening efficiency of the trommel. The invention also relates to a method for estimating media height and mass flow rate at any point within the trommel.

### BACKGROUND OF THE INVENTION

A trommel (from the German word for drum), is a screened cylinder used to separate materials by size—for example, separating biodegradable fraction of mixed municipal waste or separating different sizes of crushed stone.

Trommels or revolving screen is one of the oldest screening devices, which is a cylindrical screen typically rotating at between 35% and 45% critical speed. Trommels are installed on a small angle to the horizontal or use a series of internal baffles to transport material along the cylinder. Trommels can be made to deliver differently sized products by using trommel screens in series from finest to coarsest.

Trommels are widely used in several screening duties including aggregate screening plants and the screening of mill discharge streams. AG (autogenous grinding), SAG (semi-auogenous grinding), and ball mill discharge streams usually pass through a trommel screen attached to the mill outlet to prevent ball scats from reaching subsequent processing equipment and to prevent a build-up of pebbles in the mill.

Trommels (cylindrical drums with perforated screens) are used in several industries, e.g. mining and recycling, for separating granular media based on their size. They commonly have single start, constant pitch spirals (screws) for transporting media along their length. While this entails easier construction, it results in non-uniform height of the media along their length which in turn results in inefficient screening.

More specifically, constant pitch spirals lead to constant media velocity along the trommel. As mass flow rate of media is maximum at inlet and minimum at exit (from loss of media from screening) this results in maximum media height at inlet and minimum at exit. As screening efficiency is expected to be higher for smaller heights, non-uniform height of media is expected to result in inefficient screening. Such loss of efficiency in screening the granular media or other particles are not acceptable in the industry as it affects the screening operation resulting in loss of time, production and money.

WO 2008/140394 discusses about small, replaceable screening units. It is not evident from the document as to how design changes can be made to increase the screening efficiency of trommels.

WO 2004/087325 discusses about a screw design for improving efficiency of heavy particle (gold, platinum, etc.) separator (also referred to as spiral concentrator). This document teaches a method of heavy particle separation, including a primary separation stage which includes the steps of dropping, accumulating, concentrating and discharging of heavy particles and/or a secondary separation stage for concentrating heavy particles which includes the steps of infeeding, stilling and retaining such particles. However it was not evident from this document that the pitch of the spiral profile can be uniquely configured to increase the screening efficiency of the trommel.

U.S. Pat. No. 7,735,656 discusses about a self cleaning trommel screening device that automatically breaks up and unclogs agglomerated material from the screen which perform the primary screening function during each rotation of the rotary screening apparatus. The self clearing screening system prescreens the material screened by the screens that define the periphery of the rotary screening apparatus.

U.S. Pat. No. 6,422,394 discusses about a continuous cleaning system to prevent clogging of screens in screening machines used to sort materials such as aggregates, such system comprising positioning a cleaning device such as a chain in line with the length of and on top of, a screen to be cleaned, and then using a motor assembly to rotate said cleaning device thereby moving it back and forth across the top of said screen, so that substantially the entire area of the top of said screen comes in contact with said rotating cleaning device, which taps or otherwise contacts the surface of said screen as it moves back and forth across the top of a screen deck, thereby dislodging any dust or other material that might otherwise clog or block the openings in said screen. In a preferred embodiment, a motor rotates the cleaning device which has the effect of driving it back and forth along a tight cable on which said pulley travels. The speed, power, and direction of the motor are subject to controls which may be easily set by an operator.

U.S. Pat. No. 6,050,423 discusses about a screen panels that are articulately distorted and wedged between lifter tubes inside of trommels for varying the orifice size, shape or distribution or repairing drum screen sections in trommel screen separators. In lieu of replacing screens on the drum framework, the drum is ordered with the largest screen opening for the anticipated application. Additional screen panels are inserted or laminated to the original drum screen to reduce or change screen openings and to produce the smaller fines. Because these small screen panels receive structural support from the drum screen, quick change screen panels can be fabricated out of many different frames, screening materials and screen opening sizes. In preferred embodiments, the smaller, lighter, framed screen panels are easily managed and quickly exchanged as required, reducing downtime and loss of production. Quick change screen panels have resilient articulately bendable semi-rigid frames and are designed to be handled manually. These individual panels can be ordered in quantity to cover the entire trommel drum or any portion thereof, or panels may have different openings for a single drum, providing great flexibility to the operator to fine tune the screening operation.

U.S. Pat. No. 5,605,233 discusses a trommel cleaner apparatus having a non-circular rotatable shaft with a plurality of flapper elements mounted thereto for wiping and cleaning engagement with a trommel is provided herein. The flapper elements each have a hub having inner and outer surfaces, with the outer surface including, a plurality of flappers extending therefrom so as to engage a trommel in cleaning operation and with the inner surface including a plurality of indexing lobes to variably position the flapper element relative to the shaft and adjacent flapper elements, thereby reducing the torque spikes applied to the trommel.

In conventional trommels, constant pitch spirals (screws) are used for transporting media along their length. As the media passes through the trommel, this results in maximum height of media at entry and minimum height at exit. The increased media height at entry of the trommel where mass flow rate is maximum, results in reduced screening efficiency.

Accordingly, there is a long felt need to provide a unique profile in the trommel which would facilitate increase in the screening efficiency. Therefore, configuration of spiral path has been made such that the screening efficiency is improved without affecting the retention time of the media.

While doing research and study for increasing the efficiency of screening in trommels, prior art searches have been performed; however none of the documents contain information on how to increase the efficiency of screening.

The present invention has solved the problem in the prior art by proposing a spiral design which ensures significant height reduction of media at inlet by increasing its velocity along the trommel. This in turn is expected to increase the screening efficiency.

The present invention meets the abovementioned long felt needs.

### OBJECTS OF THE INVENTION

The primary object of the present invention is to provide a trommel assembly with decaying pitch spiral to increase the overall screening efficiency of trommels.

A further object of the invention is to ensure uniform screening over the entire length of the trommel.

Another object of the invention is to provide similar retention time for the material inside the trommel screen while in operation as in a conventional trommel screen.

Yet another object of the invention is to screen same amount of feed in a reduced trommel size.

A further object of the invention is to achieve significant reduction of media height at inlet by increasing linear media velocity and to increase the media height at exit by lowering the linear velocity along the trommel. This results in increased screening efficiency.

Another object is to provide a trommel assembly which is precision made and economic.

How the foregoing objects are achieved will be clear from the following description. In this context it is clarified that the description provided is non-limiting and is only by way of explanation.

### SUMMARY OF THE INVENTION

A trommel assembly with decaying spiral pitch comprises of a rotating drum structure with the decaying spiral assembly mounted inside it and a plurality of screen panels made of polymeric material or rubber compounds. The decaying spiral assembly pitch is maximum at the feed end, also called the inlet end and minimum at the discharge end, also called the exit end, which provides an increased screening efficiency.

The maximum pitch of the decaying spiral pitch keeps the media height low at the feed end resulting in increase of the linear media velocity at the inlet end and the minimum pitch increases the media height towards the discharge end. The decaying spiral is either of single start, or double start or multi start configuration depending upon the application that the trommel is subjected to.

The decaying spiral comprises of a plurality of individual modules designed as standardised exchangeable units to be mounted one after the other to generate a spiral form.

The screen panels have a plurality of apertures of pre-determined sizes on the panel surface so as to screen out the desired particles from the undesired ones.

The design of the spiral is such that its pitch decreases along the trommel in such a manner that screening efficiency is improved without affecting the retention time of the media.

### BRIEF DESCRIPTION OF THE ACCOMPANYING DRAWINGS

The nature and scope of the present invention will be better understood from the accompanying drawings, which are by way of illustration of a preferred embodiment and not by way of any sort of limitation. In the accompanying drawings: —

FIG. 1 is a perspective view of the complete trommel structure assembly along with decaying spiral according to the present invention.

FIG. 2a and FIG. 2b are perspective views of decaying single start and double start spiral assemblies respectively.

FIG. 3 is the top view of the decaying spiral assembly showing the progressive difference in pitch distances.

FIG. 4 is the front view of a decaying spiral assembly.

FIG. 5 is a perspective view showing a single unit or module of spiral fixed on the trommel screen panel, a plurality of such spiral modules making the complete spiral assembly or the decaying spiral assembly of FIG. 2.

FIG. 6 is a graphical representation of the height of the media as a function of its distance along the trommel for a trommel of 5 m length and 3.4 m diameter for different values of spiral pitch at inlet for exponentially decaying spirals.

FIG. 7 shows a graph illustrating exit mass flow rates for different values of spiral pitch at inlet for exponentially decaying spirals.

### DETAILED DESCRIPTION OF THE INVENTION

Having described the main features of the invention above, a more detailed and non-limiting description of a preferred embodiment will be given in the following paragraphs with reference to the accompanying drawings.

In all the figures, like reference numerals represent like features. Further, the shape, size and number of the devices shown are by way of example only and it is within the scope of the present invention to change their shape, size and number without departing from the basic principle of the invention.

The number of components shown is exemplary and not restrictive and it is within the scope of the invention to vary the shape and size of the apparatus as well as the number of its components, without departing from the principle of the present invention.

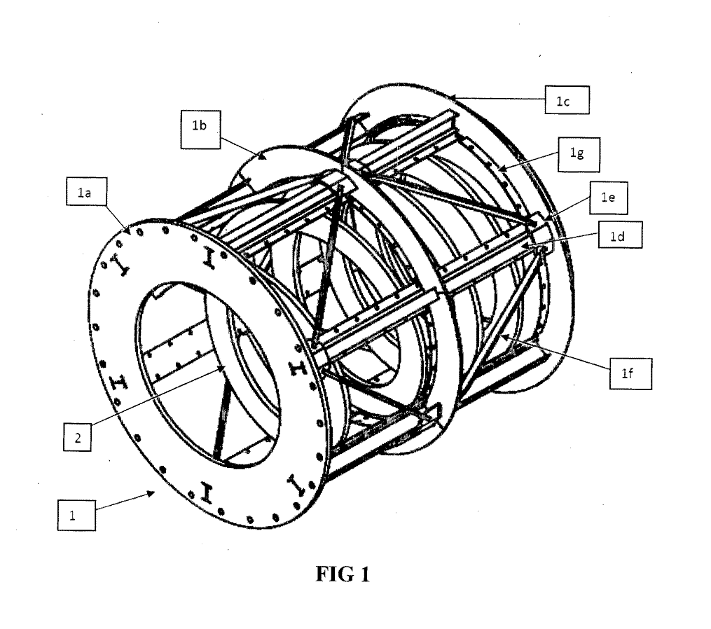

FIG. 1 depicts the complete trommel structure assembly (1) along with the decaying spiral assembly (2) mounted inside it.

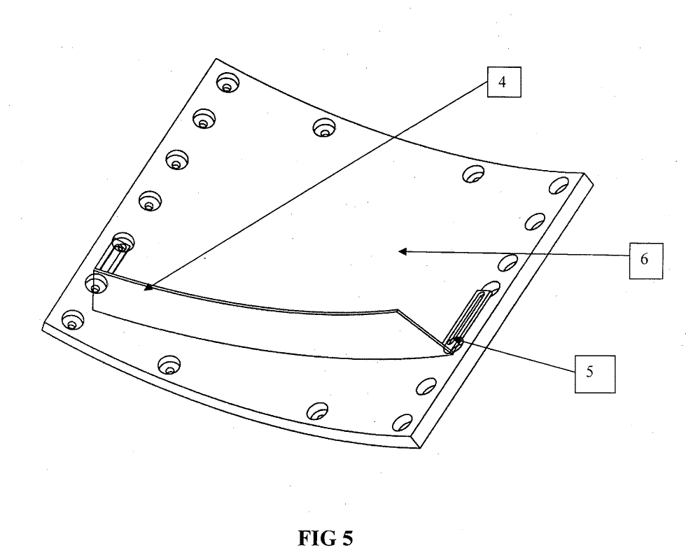

The trommel drum comprises of the main flange (1a) through which the trommel assembly (1) is fixed to the mill discharge (not seen in the fig) through suitable fixing media such as bolts or rivets. The longitudinal members or the main beams (1d) are connected to the main flange (1a) of the trommel. The main beams (1d) are the main load carrying members. The auxiliary flanges (1b) can be single unit or a plurality depending upon the length of the trommel assembly (1). The auxiliary flanges (1b) are the connecting units to which punched plates (not shown) are attached holding the screen panels (6), best shown in FIG. 5, in place. The decaying pitch spiral (2) is fixed on the inside face of the panels (6) through a plurality of punched plates. The punched plates are plates with holes on them for fixing the panels (6) and the spirals (2). The decaying spiral assembly (2) is fixed onto the screen panels (6) by using suitable fixing means (5), better shown in FIG. 5.

The discharge flange (1c) closes the trommel assembly structure (1). The main beams (1d) and the flanges (1b) and (1c) are connected using bracing members (1f) using gussets which act as a connecting media between them.

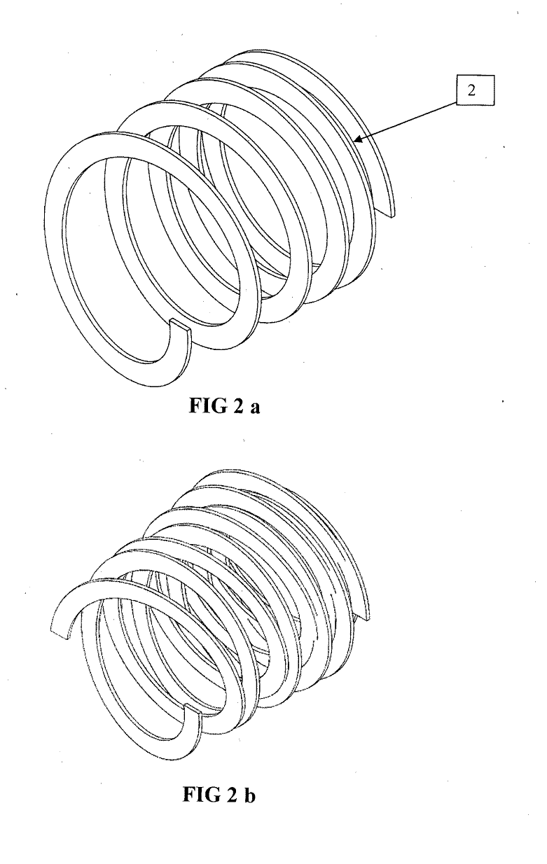

FIG. 2a shows a complete unit of a single start decaying spiral (2). The decaying spiral comprises of spiral turns characterized in that the spiral turns have varying pitch distances between successive turn. This results in an improvement of the screening efficiency without affecting the retention time of the media. More particularly, the gaps between the successive spiral turns near the inlet are higher than the gaps between the spiral turns near the exit. This unique feature of decaying spiral pitch (3) helps in keeping the media height lower at the inlet resulting in increase of the liner velocity at the inlet end while towards the exit the closer spiral turns helps increase the media height, thereby reducing the liner velocity along the trommel assembly. The assembly of a decaying spiral within a trommel is best shown in FIG. 5. In other embodiments of the present invention, the decaying spiral (2) can be a single unit or a single part which is fixed to the trommel screen panel (6) and in-turn the trommel assembly structure (1).

FIG. 2b shows a double start decaying pitch spiral (2b). It comprises of two single start decaying spirals shown in FIG. 2a spaced within each other.

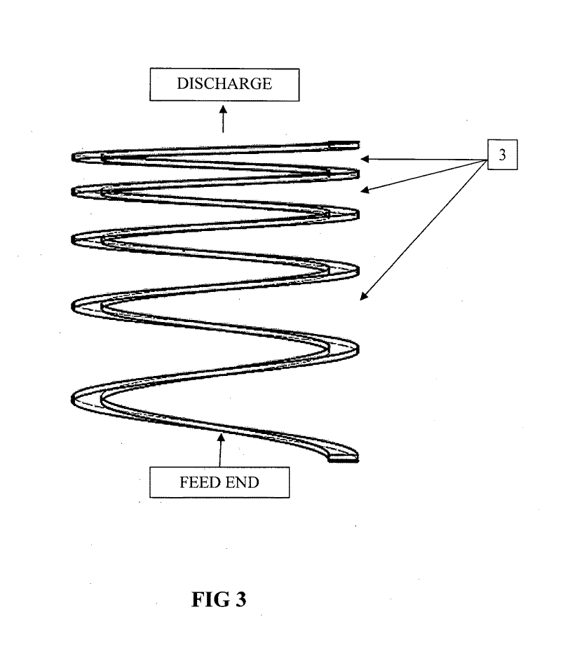

FIG. 3 illustrates the decaying spiral assembly (2) that varies along the length of the trommel structure (1). The pitch of a decaying spiral is the width of one complete helix turn, measured parallel to the axis of the helix. The pitch (3) of the decaying spiral (2) decreases from the feed end, which is the inlet, towards the discharge end, or the exit end. Hence the pitch (3) is maximum at the feed end and minimum at the discharge end. This results in a retention time that is similar to that of the conventional spiral in a trommel, but reduces the overall length of the trommel as the same amount of material can be handled in a reduced volume. Therefore it leads to a reduction in the size of the trommel assembly (1).

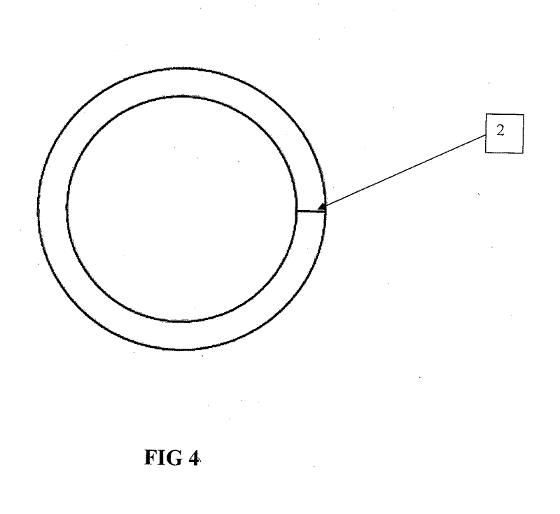

FIG. 4 depicts the front view of decaying spiral (2) as seen at the start of the trommel. The spiral is best shown in FIG. 2 described earlier. The spiral (2) can be of single start configuration, double start configuration or multi start configuration i.e. the number of spirals (2) being used together can vary substantially depending upon the application that the trommel is subjected to.

FIG. 5 shows a single trommel screen panel unit (6). The panel shown here is a non-perforated one but in other embodiments of the present invention the screen panel (6) can be perforated so as to allow materials to pass through. Panels (6) are provided with perforations for allowing particles lesser than the size of the perforation to pass through. More commonly the screen panels have a plurality of apertures of pre-determined sizes on the panel surface so as to screen out the desired particles from the undesired.

The decaying spiral (2) can either be a single unit or be assembled out of small spiral modules (4) assembled back to back and held in place by means of fixing arrangements (5) throughout the screen panel (6) and the trommel structure (1). The spiral modules (4) are designed as exchangeable units intended to be mounted one after the other to give a spiral form perpendicular to the inner surface of the ring-shaped sieving deck of the trommel screen, the deck consisting of screen panels (6) provided with holes and mounted on the rotating structure.

The purpose of the decaying spiral along with the trommel is to provide an increased screening efficiency. The same amount of screening material as in a conventional trommel is provided, but the same amount of material can now be accommodated in a lesser volume of space on the reduced sized trommel which has the decaying spiral. Thereby, the screening efficiency increases.

The spiral pitch controls the linear velocity of granular media in a trommel, which in turn dictates the height of the media at any point in the trommel. In this invention a spiral design is proposed where its pitch decreases along the trommel in such a manner that screening efficiency is improved without affecting the retention time of the media.

The invention monitors the flow of granular media trough the trommel in terms of two fitting parameters that were estimated using inlet and outlet mass flow rate for trommels and using the fact that the screening efficiency is higher when media height in the trommel is smaller. This proposed exponentially decaying pitched spiral trommel uses maximum height of media as a function of distance along the trommel for different spiral designs and radii of the trommel. The pitch of the trommel inlet is chosen by the user and the distance of the corresponding pitch are calculated using an exponential function of the media height and the distance travelled, considering that the time taken by the media to travel both constant pitch and exponentially varying pitch is identical.

The decaying spiral can be a single unit or an assembly of a plurality of spiral modules. In the latter case, the modules as standard units reduces both manufacturing time and spares inventory. The decaying spiral unit can be made of polymeric material and in some cases they can be reinforced with steel structures put inside to give additional strength.

Decaying pitch, e.g. exponentially decaying spirals lead to nearly constant media height along the length of trommels which improves the screening efficiency of trommels. Larger pitch at inlet would result in an increase in media velocity and decrease in media height (for a given inlet mass flow rate), while a smaller pitch at exit would result in a decrease in media velocity and an increase in media height. Therefore, through correct spiral design a nearly constant media height with highly increased screening efficiency can be obtained.

The design allows for user specification of spiral pitch at inlet whereas exit pitch is estimated based on the criterion that the retention time for proposed spirals would be identical to that of a reference constant pitch spiral.

In addition, an analytical model and a corresponding computer program implemented method have been developed for estimating media height variation and mass flow rate at any point within the trommel. The model thus provides an estimate for screening efficiency (exit mass flow rate of media) for a given trommel size (length and radius), trommel angular speed, coefficients of friction between grains in the media and between the media and the screen panels, inlet mass flow rate of media, apparent density of media, pitch of the spiral at inlet (for exponentially decaying spirals defined above) and pitch of the constant pitch spiral trommel which is used as the reference for judging the screening performance of the trommel. Note that the model (i.e. program) needs to be calibrated using data from a constant pitch spiral trommel before being used to estimate screening efficiencies for different spiral designs.

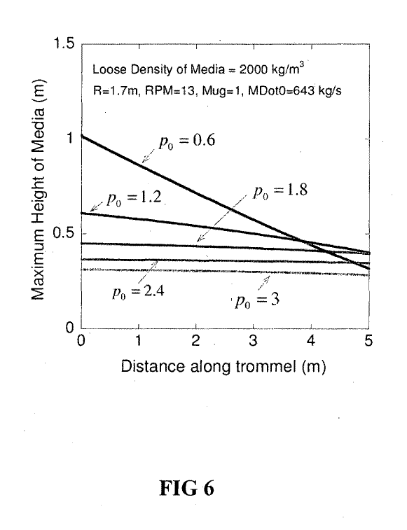

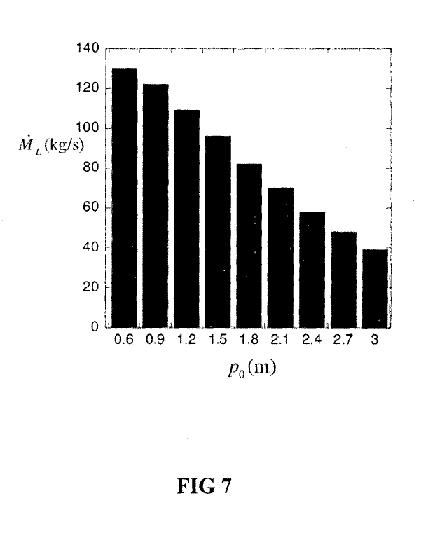

The design is amenable to analytical analyses. The analytical model takes trommel size (length and radius), its angular speed, coefficients of friction between grains in media and between the media and the screen panels, inlet mass flow rate of media, apparent density of media, pitch of the spiral at inlet (for exponentially decaying spirals defined above) and pitch of the constant pitch spiral trommel used as the reference inputs and estimates height variation of media and media mass flow rate at any point within the trommel as outputs. The model needs to be calibrated using data from a constant pitch spiral trommel used as reference. The outputs are shown in FIGS. 6 and 7 described below.

FIG. 6 shows height of the media as a function of length along the trommel for a trommel having a length between 4.5 m and 5.5 m, most preferably 5 m, and having a diameter between 3.25 m and 3.75 m, most preferably 3.4 m, for different values of spiral pitch at inlet for exponentially decaying spirals. The reference trommel has a constant pitch of 0.6 m and inlet and exit mass flow rates of 643 and 130 kg/s. Other data used in analyses are depicted in FIG. 5. Results show that height of media is nearly constant along the trommel for exponentially decaying spirals with inlet pitch of 1.8 m or more.

FIG. 7 shows a graph illustrating exit mass flow rates for different values of spiral pitch at inlet for exponentially decaying spirals. The parameters used in analytical model for estimating the exit mass flow rates are marked in FIG. 6. Considerable improvement in screening efficiency is achieved by increasing the pitch at the inlet.

Advantages of the decaying spiral trommel assembly:
Overall screening efficiency of the trommel is increased.
A size reduction of the trommel can be achieved with respect to a given entry and exit mass flow rate for a constant pitch trammel.
Uniform screening is ensured over the entire length of the trammel.

The present invention has been described with reference to some drawings and a preferred embodiment purely for the sake of understanding and not by way of any limitation and the present invention includes all legitimate developments within the scope of what has been described herein before and claimed in the appended claims.

1. A trommel assembly with decaying spiral pitch comprising:
a rotating drum structure with the decaying spiral assembly mounted inside it and a plurality of screen panels made of polymeric material or rubber compounds, the pitch of the decaying spiral assembly being maximum at the feed end and minimum at the discharge end, thereby providing increased screening efficiency.

2. The trommel assembly as claimed in claim 1, wherein said maximum pitch of decaying spiral pitch keeps the media height low at the feed end resulting in increase of the linear media velocity at the feed end and said minimum pitch increases the media height towards the discharge end.

3. The trommel assembly as claimed in claim 1, wherein said decaying spiral is either of single start configuration, or of double start configuration or of multi start configuration depending upon the application that the trommel is subjected to.

4. The trommel assembly as claimed in claim 1, wherein the decaying spiral comprises of a plurality of individual modules designed as standardized exchangeable units which are mounted one after the other to generate a spiral form.

5. The trommel assembly as claimed in claim 1, wherein the screen panels have a plurality of apertures of pre-determined sizes on the panel surface so as to screen out the desired particles from the undesired ones.

6. The trommel assembly as claimed in claim 1, wherein pitch of said decaying spiral decreases along the trommel in such a manner that screening efficiency is improved without affecting the retention time of the media.
